(19) United States
(12) Patent Application Publication
(10) Pub. No.: US 2025/0304077 A1
(43) Pub. Date: Oct. 2, 2025

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Masayuki Sato, Wako-shi (JP)

(21) Appl. No.: 19/066,212

(22) Filed: Feb. 28, 2025

(30) Foreign Application Priority Data
Mar. 28, 2024 (JP) 2024-053599

(51) Int. Cl. B60W 40/08; B60W 50/14

(52) U.S. Cl. CPC B60W 40/08; B60W 50/14; B60W 2050/146; B60W 2540/22

(57) ABSTRACT

A driving assistance device includes an analysis unit configured to analyze a driving behavior of a driver on the basis of a recognized situation around the vehicle and a detected behavior of the vehicle, a questioning unit configured to generate a question about a driving of the vehicle on the basis of the driving behavior and output the question to the output unit when a predetermined condition is met, and a storage unit configured to store correlation data indicating a correlation between a result of the analysis and a result of the reply of the driver, in which the questioning unit selects a question to be output a next time by referring to the correlation data stored in the storage unit on the basis of a driving behavior of the driver analyzed.

### CROSS-REFERENCE TO RELATED APPLICATION

Priority is claimed on Japanese Patent Application No. 2024-053599, filed Mar. 28, 2024, the content of which is incorporated herein by reference.

### BACKGROUND OF THE INVENTION

### Field of the Invention

The present invention relates to a driving assistance device, a driving assistance method, and a storage medium.

### Description of Related Art

In recent years, there has been increased effort to provide an access to sustainable transport systems that take into consideration vulnerable transport participants. To realize this, research and development to further improve the safety and convenience of traffic through research and development related to a preventive safety technology has been mainly focused upon.

In the preventive safety technology, assistance systems for driving moving objects are being developed. For example, in the technology described in Patent Document 1 described below, driving assistance is performed on the basis of emotions of the driver obtained by collating an external environment of the vehicle and driving skills of the driver with an emotion map created in advance. A plurality of emotion maps are set according to a plurality of different driving assistances, and the driving assistance device performs driving assistance so that the emotions of the driver obtained from each of the plurality of emotion maps become pleasant emotions.

[Patent Document 1] Japanese Unexamined Patent Application, First Publication No. 2015-128989

### SUMMARY OF THE INVENTION

However, with the conventional technology, it has not been possible to ascertain whether a positive impact is being exerted on driving of the driver. It has also not been possible to know whether the driver is satisfied with the assistance system. For this reason, with the conventional technology, there have been cases where a quality of driving cannot be improved.

Aspects of the present invention have been made in consideration of the problems described above, and one of the objects of the present invention is to provide a driving assistance device, a driving assistance method, and a storage medium that can assist in improving the quality of driving. This will ultimately contribute to the development of a sustainable transportation system.

The present invention has adopted the following aspects to solve the problems described above.
(1): A driving assistance device according to one aspect of the present invention includes a recognition unit configured to recognize an external environment of a vehicle, a detection unit configured to detect a behavior of the vehicle, an analysis unit configured to analyze a driving behavior of a driver on the basis of a situation around the vehicle recognized by the recognition unit and the behavior of the vehicle detected by the detection unit, an output unit configured to output at least one of an image and audio to the driver, an input unit configured to receive an input operation from the driver, a questioning unit configured to generate a question about a driving of the vehicle on the basis of the driving behavior and output the question to the output unit when a predetermined condition is met, a memory unit configured to memorize a result of a reply of the driver to the question, input by the input unit, and a storage unit configured to store correlation data indicating a correlation between a result of the analysis by the analysis unit and a result of the reply of the driver, input by the input unit, in which the questioning unit selects a question to be output by the output unit a next time by referring to the correlation data stored in the storage unit on the basis of a driving behavior of the driver analyzed by the analysis unit.
(2): In the aspect of (1) described above, the driving assistance device may further include an estimation unit configured to estimate emotions of the driver on the basis of a result of the reply of the driver to at least content to be output by the output unit.
(3): In the aspect of (2) described above, the estimation unit may update the correlation data stored in the storage unit on the basis of the estimated emotion information of the driver.
(4): In the aspect of any one of (1) to (3) described above, the output unit may be a display unit and display the content to be output, and the input unit may be a touch panel sensor and receive an input of a reply to the content to be output from the driver.
(5): In the aspect of (4) described above, the input unit may detect a result of moving coordinates of a pointer image by a touch operation in response to a question presented on the display unit, thereby receiving an input operation for the content to be output.
(6): In the aspect of (4) described above, the input unit may receive an input operation for the content to be output by touching an emotion model drawn on the display unit.
(7): A driving assistance method for providing driving assistance according to another aspect of the present invention includes recognizing, by a recognition unit, an external environment of a vehicle, detecting, by a detection unit, a behavior of the vehicle, analyzing, by an analysis unit, a driving behavior of a driver on the basis of a situation around the vehicle recognized by the recognition unit and the behavior of the vehicle detected by the detection unit, outputting, by an output unit, at least one of an image and audio to the driver, receiving, by an input unit, an input operation from the driver, generating, by a questioning unit, a question about a driving of the vehicle on the basis of the driving behavior and outputting the question to the output unit when a predetermined condition is met, memorizing, by a memory unit, a result of a reply of the driver to the question, input by the input unit, and storing, by a storage unit, correlation data indicating a correlation between a result of the analysis by the analysis unit and a result of the reply of the driver, input by the input unit, in which the questioning unit selects a question to be output by the output unit a next time by referring to the correlation data stored in the storage unit on the basis of a driving behavior of the driver analyzed by the analysis unit.
(8): A computer-readable non-transitory storage medium according to still another aspect of the present invention memories a program causing a computer of a driving assistance device that provides driving assistance to execute recognizing, by a recognition unit, an external environment of a vehicle, detecting, by a detection unit, a behavior of the vehicle, analyzing, by an analysis unit, a driving behavior of a driver on the basis of a situation around the vehicle recognized by the recognition unit and the behavior of the vehicle detected by the detection unit, outputting, by an output unit, at least one of an image and audio to the driver, receiving, by an input unit, an input operation from the driver, generating, by a questioning unit, a question about a driving of the vehicle on the basis of the driving behavior and outputting the question to the output unit when a predetermined condition is met, memorizing, by a memory unit, a result of a reply of the driver to the question, input by the input unit, storing, by a storage unit, correlation data indicating a correlation between a result of the analysis by the analysis unit and a result of the reply of the driver, input by the input unit, and selecting a question to be output a next time by referring to the stored correlation data on the basis of the analyzed driving behavior of the driver.

According to the aspects (1) to (8) described above, it is possible to provide assistance to improve a quality of driving.

According to the aspects (1), (7), and (8) described above, since content to be provided to the driver can be optimized by using correlation data in which the analyzed driving behavior is associated with the emotions of the driver, acceptability and persuasiveness of the content can be encouraged. According to the aspects (1), (7), and (8) described above, repeated training is performed using the provided content, and as a result, metacognitive ability can be fostered and a probability of noticing changes in driving behavior that improve driving can be increased.

According to the aspect (2) described above, since the emotions of the driver for driving results are estimated on the basis of the result of the question reply, satisfaction of the driver with the content can be improved.

According to the aspect (3) described above, the reliability of the correlation data can be improved by not only relying on the question reply that leaves the emotion information to a memory of the driver, but also monitoring facial expressions and speech of the driver using images captured by cameras such as a driver monitor camera that monitors the driver with objective data, or a smartphone, or acquiring vital information from detection devices such as a wearable terminal worn by the driver or a steering grip sensor, and using these together with the result of the question reply of the driver. According to the aspect (3) described above, for example, when there is a predetermined or greater discrepancy between the question reply of the driver and the vital information, which is objective data, the correlation database is updated with the vital information as a priority. As a result, it is possible to complement a reply mistake of the driver.

According to the aspect (4) described above, the input unit and output unit are integrated into a touch panel display to form an interface, and the driver replies to questions through a display unit (for example, an in-vehicle display device or audio playback device, or an information terminal device such as a smartphone or tablet terminal carried by a vehicle passenger). As a result, according to the aspect (4) described above, the input unit can input a reply of the driver by touching the questions displayed on the screen. According to the aspect (4) described above, a simple operation by a touch operation (for example, a gesture operation by tapping or swiping) is possible for each question, so that an operational burden on the driver when replying to the questions can be reduced.

According to the aspect (5) described above, the driver can reply intuitively to questions, so that the operational burden on the driver when replying to the questions can be reduced

According to the aspect (6) described above, by using, for example, a Russell Circumplex model as an emotion model, it is possible not only to reduce the operational burden on the driver through an intuitive operation, but it is also possible to quantitatively evaluate emotions, such as changes in emotions of the driver by converting the coordinates into scores.

### BRIEF DESCRIPTION OF THE DRAWINGS

FIG. 1 is a configuration example of a driving assistance device according to a first embodiment.

FIG. 2 is a flowchart of a schematic procedure of processing according to the first embodiment.

FIG. 3 is a diagram which shows an example of correlation between a driving behavior improvement effect and a user effect.

FIG. 4 is a diagram which shows an example of a question image presented to a driver.

FIG. 5 is a diagram which shows another example of an emotion input when a question is asked.

FIG. 6 is a diagram which shows an example of an analysis result on the basis of traveling data and information indicating an input emotion.

FIG. 7 is a diagram which shows another example of an emotion selection method.

FIG. 8 is a diagram which shows an example of a target emotion area.

FIG. 9 is a diagram which shows a configuration example of a driving assistance device according to a second embodiment.

FIG. 10 is a flowchart of a schematic procedure of processing according to the second embodiment.

### DETAILED DESCRIPTION OF THE INVENTION

Hereinafter, an embodiment of the present invention will be described with reference to the drawings. In the drawings used in the following description, a scale of each component is appropriately changed so that each component can be recognized.

In all drawings used to describe the embodiment, the same reference numerals are used for components having the same functions, and repeated descriptions will be omitted.

“On the basis of XX” in this application means “based on at least XX” and includes cases of being based on another element in addition to XX. “On the basis of XX” is not limited to cases of using XX directly, but also includes cases of being based on XX that has been subjected to calculation or processing. “XX” is any element (for example, any types of information).

### First Embodiment

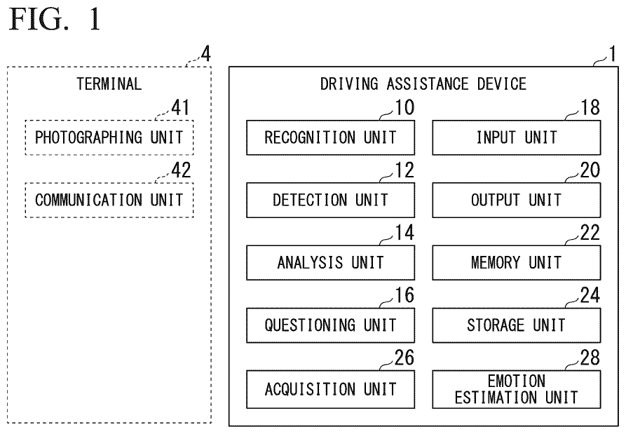

FIG. 1 shows a configuration example of a driving assistance device according to the present embodiment. As shown in FIG. 1, a driving assistance device 1 includes, for example, a recognition unit 10, a detection unit 12, an analysis unit 14, a questioning unit 16, an input unit 18, an output unit 20, a memory unit 22, a storage unit 24, an acquisition unit 26, and an estimation unit 28.

### Driving Assistance Device

The driving assistance device 1 can also be realized by an application and a central processing unit (CPU). For example, an application that executes functions of the driving assistance device can be installed on a smartphone, a tablet terminal, or the like, and executed by the smartphone, the tablet terminal, or the like, or executed by a Web application. The driving assistance device 1 may transmit and receive information to and from the terminal 4 via a wireless line.

The recognition unit 10 recognizes a situation around a vehicle. The situation around the vehicle may be recognized, for example, by recognizing traffic congestion on the basis of an image captured by an in-vehicle camera. Alternatively, whether a road on which the vehicle is traveling is an urban area, a country road, a highway, a general road, or the like may be acquired from a car navigation system and recognized. The recognition unit 10 may include sensors such as a radar that measures a distance to an object using radio waves and a lidar that measures the distance to an object and the shape of the object using laser light, in addition to a camera, and may recognize moving objects such as traffic participants and objects such as stationary objects by appropriately using or integrating these sensors.

The detection unit 12 detects a behavior of the vehicle. The detection unit 12 detects data related to the behavior of the vehicle from instruments of the vehicle, for example, via a wireless network. The behavior of the vehicle may be, for example, a start of driving, an end of driving, traveling data, and the like. The traveling data includes, for example, data on a traveling position of the vehicle, an acceleration or deceleration of the vehicle by operating the brake pedal or accelerator pedal, steering conditions by operating the steering wheel, a driving speed of the vehicle by an output from the vehicle speed sensor and wheel speed sensor, an acceleration in forward and backward directions and left and right directions of the vehicle by an output from the acceleration sensor, and a rotation speed of the traveling drive source by an output of the rotation speed sensor.

The analysis unit 14 analyzes a driving behavior of the driver (user) on the basis of the situation around the vehicle recognized by the recognition unit 10 and the behavior of the vehicle detected by the detection unit 12.

The questioning unit 16 selects a question (content) to be output a next time on the basis of the driving behavior of the driver analyzed by the analysis unit 14, by referring to correlation data stored by the storage unit 24. For example, when the driving assistance device 1 is started after the driver returns home after driving to perform a driving diagnosis, a first question presented is a question for the first time, and a next question presented is a question for the next time. In the present embodiment, when the driver replies to the question for the first time in a manner that makes him or her feel uncomfortable, a different question is asked the next time. Content presented by the questioning unit 16 is not limited to inquiries, but may also be suggestions or advice. In the embodiment, an image, text, or the like presented by the questioning unit 16 is referred to as content. The questioning unit 16 presents questions, suggestions, and advice-like content after driving as a review after driving. The questions may be any one of text, audio, still images, videos, text and still images, text and videos, audio and still images, audio and videos, and the like.

The input unit 18 receives an input operation from the driver. The input unit 18 is, for example, a touch panel sensor provided on a display device.

The output unit 20 outputs at least one of an image and audio to the driver. The output unit 20 is, for example, at least one of a display device (a display unit) and a speaker. The input unit 18 and the output unit 20 may include an in-vehicle display device equipped with a display unit and a touch panel sensor, an audio playback device, or the like.

The memory unit 22 memorizes results of the replies of the driver to questions input into the input unit 18. The memory unit 22 memorizes content presented to the driver.

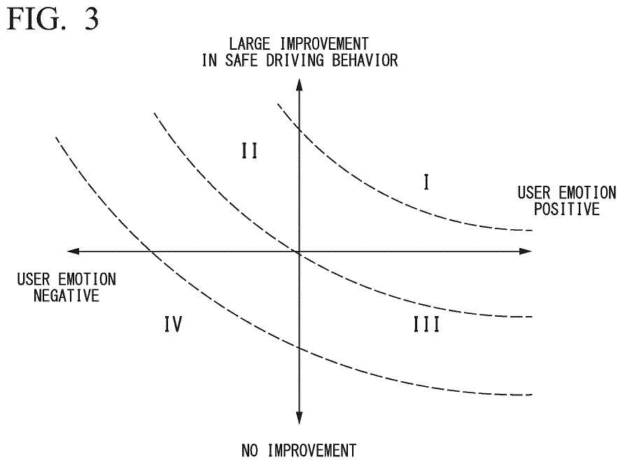

The storage unit 24 associates and stores correlation data indicating correlation between analysis results analyzed by the analysis unit 14 and reply results of the driver input to the input unit 18. The correlation data is, for example, data such as that shown in FIG. 3, which indicates correlation between an effect of each presented content (question, content) and acceptability of the presented content. The storage unit 24 is a database and may be provided on a cloud or connected via a network.

The acquisition unit 26 acquires captured image data from the terminal 4.

The estimation unit 28 extracts a facial area of the driver from the image data acquired by the acquisition unit 26, and performs well-known image processing (binarization, feature extraction, clustering, contour extraction, and the like) on an image of the extracted facial area, or inputs it into a learned model to estimate emotions of the driver from a facial expression. The estimation unit 28 estimates the emotions of the driver on the basis of at least the results of the replies of the driver to question content. The estimation unit 28 may also capture an image of the driver while driving and estimate the emotions of the driver using the captured image. The estimation unit 28 updates the correlation data stored by the storage unit 24 on the basis of information on the estimated emotions of the driver. When the terminal 4 is a device for detecting vital information, the estimation unit 28 can improve reliability of the correlation data by using the replies of the driver to questions together with the vital information. For example, when there is a predetermined or greater discrepancy between the replies of the driver to the questions and the vital information, which is objective data, the estimation unit 28 updates the correlation database by prioritizing the vital information. As a result, according to the present embodiment, it is possible to complement a reply mistake of the driver. The vital information is, for example, biological information of the driver obtained by measuring a body temperature, a pulse, a heart rate, a blood pressure, a blood oxygen concentration, a sweat rate, and the like using various sensors embedded into a wearable terminal, and the emotions of the driver can be estimated on the basis of these pieces of the biological information. An output of a steering grip sensor embedded into the steering wheel can also be acquired as the vital information. In this case, by acquiring vital information such as a gripping force with which the driver grips the steering wheel or an amount of sweating of the fingers, it is possible to estimate the emotions of the driver, particularly a degree of tension of the driver.

### Terminal

The terminal 4 is, for example, a smartphone, a tablet terminal, a car navigation device, a drive recorder, a driver monitor camera that monitors the driver, or the like. The terminal 4 includes, for example, a photographing unit 41 and a communication unit 42. Alternatively, the terminal 4 may be, for example, a wearable terminal (including a smart watch). In this case, the wearable terminal does not need to include the photographing unit and detects vital information. The terminal 4 may be, for example, an in-vehicle display device equipped with a display unit and a touch panel sensor, an audio playback device, or the like.

The photographing unit 41 photographs a range including a face of the driver, for example, at predetermined intervals or at predetermined times while the driver is driving the vehicle.

The communication unit 42 transmits the image photographed by the photographing unit 41 to the driving assistance device 1.

### Processing Procedure

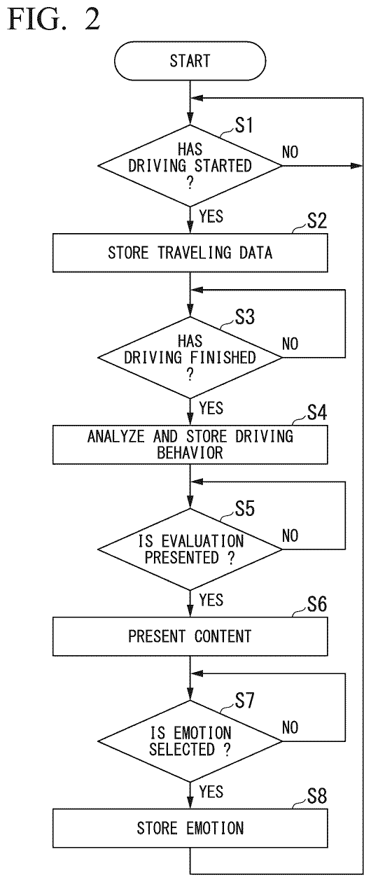

Next, an example of a schematic procedure for the processing of the present embodiment will be described. FIG. 2 is a flowchart of the schematic procedure for the processing of the present embodiment.

The detection unit 12 determines whether the driver has started driving the vehicle (step S1). When the driver has not started driving the vehicle, the detection unit 12 repeats processing of step S1.

When the driver has started driving the vehicle, the detection unit 12 detects the traveling data, associates the detected traveling data with driver identification information indicating the driver, and stores a result of the association in the storage unit 24 (step S2).

The detection unit 12 determines whether the driver has finished driving the vehicle (step S3). When the driver has not finished driving the vehicle, the detection unit 12 repeats processing of step S3.

The analysis unit 14 analyzes the traveling data stored during traveling, associates a result of the analysis or a result of evaluation with the driver identification information, and stores a result of the association in the storage unit 24 (step S4).

The input unit 18 determines whether the driver has input an instruction to display content (step S4). When the driver has not input an instruction to display content, processing of step S5 is repeated. For example, the driver starts the driving assistance device 1 after he or she drives the vehicle to return home.

When the driver has input an instruction to display content, the analysis unit 14 reads out the content on the basis of the result of the analysis or the result of the evaluation from the memory unit 22, and presents the read content to the driver from the output unit 20. Next, the questioning unit 16 prompts the driver to select the information that indicates his or her emotion as a result of viewing or listening to the presented content (step S6). The analysis unit 14 may start the analysis or evaluation of the driving behavior after the driver inputs an instruction to display the content, or may perform the analysis or evaluation while the vehicle is traveling. The analysis unit 14 selects the content that is predetermined according to a driving behavior of the driver only the first time. Examples of the content will be described below.

The input unit 18 determines whether the driver has selected information that indicates his or her emotion as a result of viewing or listening to the presented content (step S7). When the driver has not selected information indicating his or her emotion, the input unit 18 repeats processing of step S7.

When the driver has selected information indicating his or her emotion, the input unit 18 associates the selected information indicating his or her emotion with the driver identification information and stores a result of the association in the storage unit 24 (step S8). After processing, the input unit 18 returns to processing of step S1.

### Question, Content

FIG. 3 is a diagram which shows an example of correlation between a driving behavior improvement effect and a user effect. A rightward direction of a horizontal axis indicates that the emotions of the driver are positive, and a leftward direction of the horizontal axis indicates that the emotions of the driver are negative. An upward direction of a vertical axis indicates that an improvement effect of a safe driving behavior is large, and a downward direction of the vertical axis indicates that the improvement effect of a safe driving behavior is small or non-existent. In a graph, an area above a first chain line is set as “I,” an area between the first chain line and a second chain line is set as “II,” an area between the second chain line and a third chain line is set as “III,” and an area below the third chain line is set as “IV.” The driving assistance device 1 uses such a graph to manage the selection of content and the correlation between a driving behavior improvement effect and a user effect. For example, the driving assistance device 1 determines content to be presented next from among a large number of contents plotted on a two-dimensional plane as shown in FIG. 3 in a priority (probability) of area I>area II>area III>area IV. A correlation diagram shown in FIG. 3 is an example, and the present invention is not limited to this.

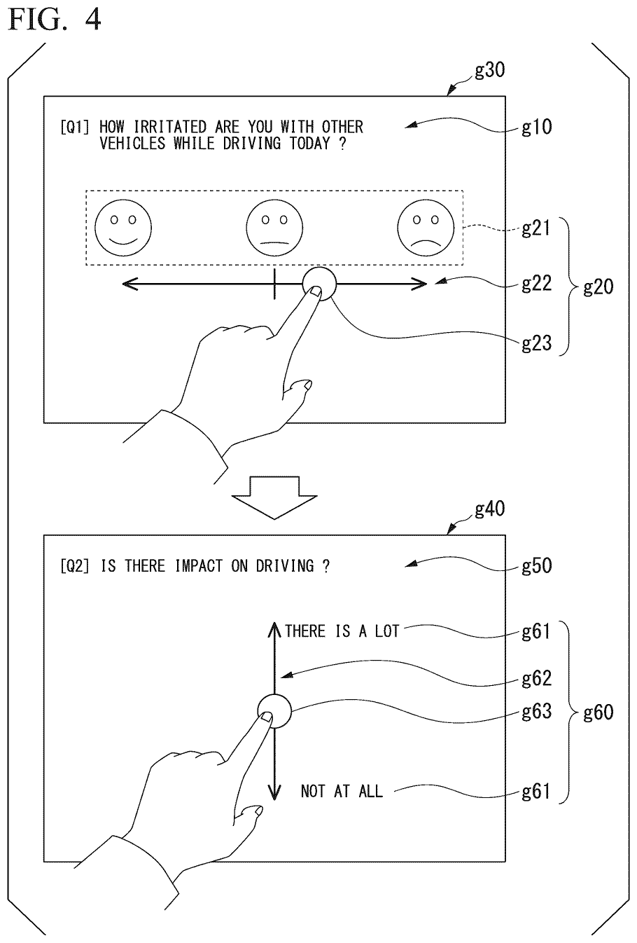

Next, an example of a question image presented to the driver will be described. FIG. 4 is a diagram which shows an example of a question image presented to the driver. In the question image, the questioning unit 16 causes the output unit 20 to display several questions for the driver after driving, and an image for selecting the emotions in response to the questions. The example in FIG. 4 is an example of an image for performing self-evaluation on emotions while driving.

An image g30 is a first question image. In the first question image g30, the questioning unit 16 causes the output unit 20 to display a question g10 and an image g20 for selecting the emotion in response to the question. The image g20 for selecting the emotion in response to the question includes, for example, an icon image g21 representing an emotion, a slider axis image g22, and a pointer image g23. The driver replies to the question by touching coordinates of the pointer image g23 and moving it to a position that matches the emotion. The driver operates the input unit 18, for example, by gesture operations such as tapping and swiping.

An image g40 is an example of a second question image that is presented after the first question image is replied. In the second question image g40, the questioning unit 16 causes the output unit 20 to display a question g50 and an image g60 for performing self-evaluation on an impact of the question on driving. The image g60 for self-evaluating the impact of the question on driving includes, for example, a text image g61 representing a degree of impact on driving, a slider axis image g62, and a pointer image g63. The driver performs the self-evaluation by touching coordinates of the pointer image g63 and moving it to a position that matches the degree of impact.

Evaluation is preferably performed at the same time of day, on the same driving route, and the like. For example, when the driver drives a vehicle to work every day, the driver can feel an improvement in driving from the previous drive more clearly by performing the evaluation regularly, such as daily or weekly. However, the operator may decide a time period and a driving route by himself or herself.

Content of the questions, the number of questions, an image of the questions and replies, and the like shown in FIG. 4 are examples, and the present invention is not limited to these. A timing of presenting the question image is preferably after an end of driving and before a next driving. A shape of the pointer image is not limited to a circle.

The analysis unit 14 estimates a psychological state of the driver during the driving behavior on the basis of replies to these questions and trace results of analyzing the traveling data (for example, the number of times of sudden braking, the number of times of sudden deceleration, a traveling speed, and the like). The analysis unit 14 selects the content to be presented on the basis of a result of the estimation. For example, when it is determined that the driving is irritating, the presented content is content that prompts the driver to drive calmly the next time.

Here, an example of a question to be asked a next time will be described. As a result of the driving behavior analysis, for example, when a question (content) presented a first time is “How irritated are you with other vehicles while driving today?”, if the driver shows a negative emotion toward this content, the same content will not be presented the next time. For example, when the questioning unit 16 refers to correlation data accumulated in the storage unit 24 and detects a driving behavior similar to a previous time (when a condition that the behavior has not been improved compared to that in the previous time is met), it presents a question (content) different from the previous time to present content that calms the emotions of the driver. In such a case, a question presented is, for example, “Take a deep breath” or “Drive at a sufficient distance from other vehicles that cause stress.” For a driver whose emotions are on a positive side in response to the question, content related to safe driving coaching (including advice on improving driving skills) is presented preferentially. In this manner, according to the present embodiment, acceptability of a question can be further improved.

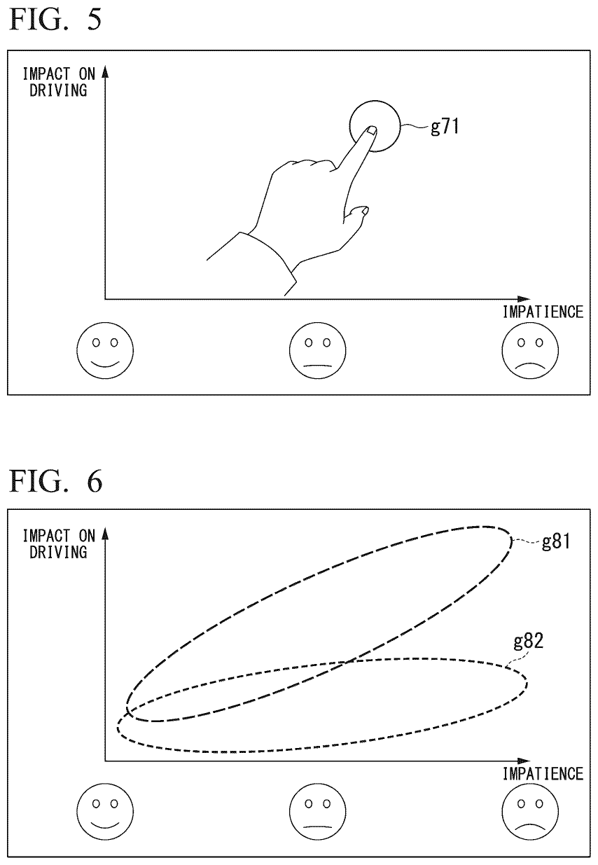

FIG. 5 is a diagram which shows another example of an emotion input during a question. The horizontal axis shows an item indicating an emotion, and the vertical axis shows an impact on driving. A question in FIG. 5 is, for example, “While driving today, what is a degree of impatience with respect to time (emotions) and the degree of impact on driving (impact on driving)?” In an example in FIG. 5, the driver directly selects emotions and impact on driving by touching and moving coordinates of the pointer image g71. The selection and input method shown in FIG. 5 is an example, and the present invention is not limited to this.

When the driver tends to be “impatient” while driving, the question may be “What is a way to stop being impatient?” In this case, a reply to the question may be selected from among, for example, “Leave earlier,” “Extend an arrival time,” “Play favorite music,” and the like. The driver may reply in audio. In this case, the acquisition unit 26 may collect an audio signal, perform well-known audio recognition processing on the collected audio signal, and convert the audio signal into text to acquire the reply.

FIG. 6 is a diagram which shows an example of an analysis result on the basis of traveling data and input information indicating emotions. The horizontal axis shows an emotion, and the vertical axis shows the degree of impact on driving. A chain line g81 is an example where emotions had an impact on the driving behavior. A chain line g82 is an example where emotions had little impact on the driving behavior. FIG. 6 is also an example of the analysis result using replies to the questions in FIG. 4 or FIG. 5 and the traveling data. FIG. 6 is a schematic diagram using scatter data, and the like, in which the driving behavior and emotions during driving are statistically processed, and the chain lines g81 and g82 each enclose a range in plotted distribution data where there is a certain correlation between the impact on driving and the emotions of the driver. Here, when a slope of the distribution drops from a range of the chain line g81 to the chain line g82, it is possible to derive an analysis result that the driving behavior has changed to a calm tendency suitable for driving. When the number of data n increases, it is also possible to use a regression line to further analyze a driving tendency in more detail.

As shown in FIG. 6, in the present embodiment, for example, it is emphasized that the emotions of the driver are not denied, and the driving behavior is not swayed by the emotions. For this reason, in the present embodiment, when the driving behavior is not influenced by the emotions, as shown by a chain line g82, it is determined that the driving behavior has improved, which is a good tendency. Then, the analysis unit 14 presents, as the analysis result, for example, data or a correlation diagram of past emotions and the impact on driving from the output unit 20. The data and graphs shown in FIG. 6 are only examples, and the present invention is not limited to these.

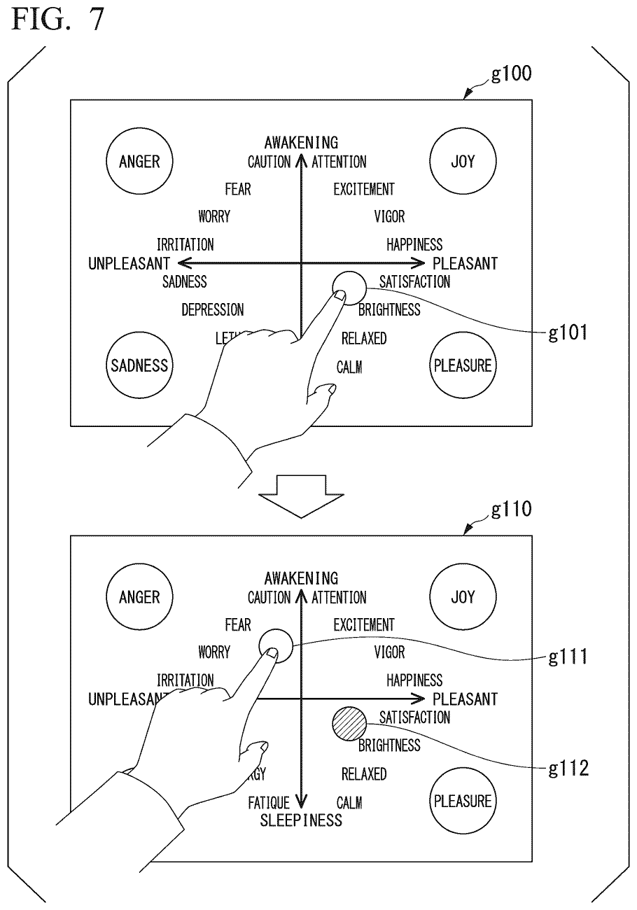

FIG. 7 is a diagram which shows another example of an emotion selection method. In the example of FIG. 7, the driver is asked about his or her mood before driving and after driving. The mood before driving is preferably acquired before driving starts, but may be acquired after driving. In the example of FIG. 7, emotions are divided into “joy,” “anger,” “sadness,” and “pleasure” and are displayed by being allocated to each phenomenon on the graph. For example, emotions classified as “joy” are “attention,” “excitement,” “vigor,” and “happiness.” A rightward direction of the horizontal axis is pleasant, and the leftward direction is unpleasant. An upward direction of the vertical axis is awakening, and the downward direction is sleepiness. As a result, it is easier for the driver to select an emotion because not only joy, anger, sadness, and pleasure but also the corresponding emotions are shown. The classification and display shown in FIG. 7 are only an example, and the present invention is not limited to this. FIG. 7 is an example of an emotion model, which is based on, for example, Russell's emotion circumplex model. For example, the estimation unit 28 may score emotions on the basis of a coordinate position of such a graph.

An image g100 is an example of an image in which a question is asked about the mood before driving and a reply is given. The driver selects the emotion before driving by touching and moving a slider axis image g101.

An image g110 is an example of an image in which a question is asked about the mood after driving and a reply is given. The driver selects the emotion after driving by touching and moving a pointer image g111. In the image g110, a pointer image g112 of the emotion selected before driving may or may not be displayed. When it is displayed, the pointer image g112 of the emotion selected before driving is presented so that it cannot be selected and cannot be moved.

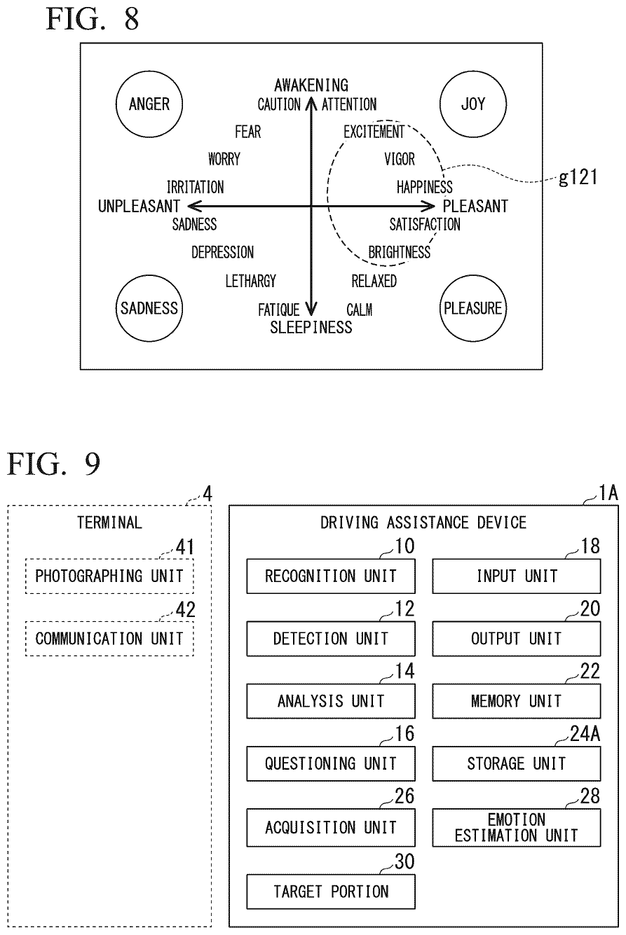

FIG. 8 is a diagram which shows an example of an area of a target emotion. In the present embodiment, assistance is provided so that the emotion after driving falls within the area enclosed by a chain circle g121. To achieve such a target, after the driver selects his or her emotions after driving, the driving assistance device 1 may ask the driver to reply about a reason for a change in emotion before and after driving, and may acquire the reply to use it for an analysis. FIG. 8 is an example of an emotion model, which is based on, for example, Russell's emotion circumplex model.

Content of the questions, the presented images, and the like shown in FIGS. 4, 5, and 7 are merely examples and the present invention is not limited to these. The questions may be presented on at least one of the question content screens shown in FIGS. 4, 5 and 7.

In this manner, in the present embodiment, the driver is made to recognize his or her own tendency on the basis of his or her own accumulated data and history in the past, that is, metacognitive ability of the driver regarding his or her own driving is made to be improved.

As described above, in the present embodiment, questions are asked by presenting driving education content and questions on the driving behavior to the driver, and replies to the questions are obtained. In the present embodiment, the driver is made to select emotions while driving, and the results are stored. Alternatively, in the present embodiment, the results of emotion estimation performed based on image data captured by the terminal 4 are stored.

In the present embodiment, a driving situation of the driver is also recorded, and a correlation between each content, the questions on the driving behavior, and driving improvement (sudden deceleration, speed reduction, and the like) of the driver is also accumulated. In the present embodiment, a correlation database is created between each content, subsequent driving results, and the emotions of the driver, and accordingly, control is performed such that content and questions on the driving behavior that are classified into a similar genre to more effective and acceptable content are preferentially presented with a high probability.

As a result, according to the present embodiment, it is possible to increase a probability that the driver will improve his or her driving skills through the content and questions on the driving behavior provided. According to the present embodiment, it is also possible to increase a probability of improving a satisfaction degree and continuity of the driver. According to the present embodiment, the probability can be further increased by using the device for a longer period of time. Furthermore, according to the present embodiment, it is possible to provide personalized safe driving education according to the individuality of each driver.

### Second Embodiment

FIG. 9 is a diagram which shows a configuration example of a driving assistance device according to the present embodiment. As shown in FIG. 9, a driving assistance device 1A includes, for example, a recognition unit 10, a detection unit 12, an analysis unit 14A, a questioning unit 16, an input unit 18, an output unit 20, a memory unit 22A, a storage unit 24, an acquisition unit 26, an estimation unit 28, and a target portion 30.

The target portion 30 reads out a previously set target from the memory unit 22A and presents the read previously set target from the storage unit 24A. The target portion 30 checks a next target with the driver, acquires the next target set by the driver, and causes the memory unit 22A to memorize the acquired next target in association with an input date and time and identification information of the driver. The target may be memorized in the storage unit 24 in association with the input date and time and the identification information of the driver.

In addition to the data stored in the memory unit 22, the memory unit 22A stores the target in association with the input date and time and the identification information of the driver.

The analysis unit 14A analyzes the replies to inquiries about driving input by the driver and the traveling data, and presents objective facts as results of the analysis from the output unit 20. The objective facts are, for example, traveling data such as changes in driving speed with frequent sudden braking and sudden acceleration, images of facial expressions of the driver while driving, vital data (heart rate, blood pressure, and the like), and the like. For example, even if the driver replies that he has been “irritated,” when the facial expression is smiling, there is a possibility that his memory has faded after driving and he is mistaken. Therefore, the analysis unit 14A or the estimation unit 28 can present data of objective facts to reduce and correct reply errors by the driver. The data stored in the storage unit 24 is updated after such things are reflected.

### Processing Procedure

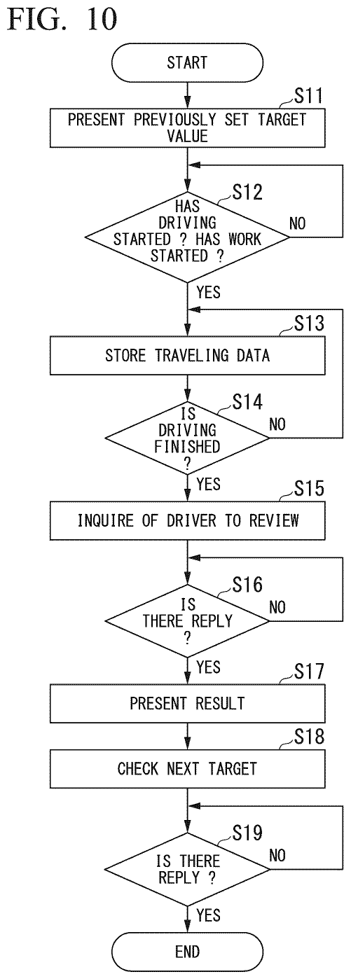

Next, an example of a schematic procedure for the processing of the present embodiment will be described. FIG. 10 is a flowchart of the schematic procedure for the processing of the present embodiment.

The target portion 30 reads out the previously set target from the storage unit 24A and presents the previously set target which has been read from the memory unit 22A (step S11).

The detection unit 12 determines whether the driver has started driving the vehicle (or started work) (step S12). When the driver has not started driving the vehicle, the detection unit 12 repeats processing of step S12.

When the driver has started driving the vehicle, the detection unit 12 detects traveling data, associates the detected traveling data with driver identification information indicating the driver, and stores a result of the association in the storage unit 24 (step S13).

The detection unit 12 determines whether the driver has finished driving the vehicle (step S14). When the driver has not finished driving the vehicle, the detection unit 12 repeats processing of step S14.

After driving, the questioning unit 16 inquires of the driver to review his or her driving behavior (step S15).

The input unit 18 determines whether the driver has input a reply to the inquiry (step S16). When the driver has not input a reply, processing of step S16 is repeated. The reply of the driver is, for example, his or her emotion after driving.

When the driver has input a reply to the inquiry, the analysis unit 14A analyzes the input reply to the inquiry and the traveling data, and presents objective facts as a result of the analysis from the output unit 20 (step S17).

The target portion 30 checks a next target with the driver and determines whether the next target has been input. When the driver has not input a reply, processing of step S18 is repeated. When the driver has input a reply, the target portion 30 acquires the next target set by the driver, associates the acquired next target with an input date and time and the identification information of the driver, and stores a result of the association in the memory unit 22A (step S18).

In the present embodiment, after the driver is presented with questions about driving education content and driving behavior, and replies, the driver is asked to select an emotion and the result is stored. Alternatively, in the present embodiment, results of emotion estimation may be stored from image data photographed by the photographing unit 21 of the terminal 4. In the present embodiment, control is performed according to the correlation between content and emotion, so that content classified into a genre similar to content with a high correlation to positive emotion and questions about the driving behavior are preferentially provided with a high probability. Alternatively, in the present embodiment, control is performed so that content and questions classified into a genre similar to the content having a high correlation with driving improvement are preferentially provided with a high probability according to the correlation.

As a result, according to the present embodiment, the driver can increase a possibility that the provided content and questions about the driving behavior will improve a satisfaction degree and continuity of the driver. According to the present embodiment, the probability can be further increased by using the device for a longer period of time. Furthermore, according to the present embodiment, it is possible to provide personalized education according to the individuality of each driver.

A program for realizing all or part of the functions of the driving assistance device 1 (or 1A) in the present invention may be recorded on a computer-readable recording medium, and the program recorded on this recording medium may be read into a computer system and executed to perform all or part of the processing performed by the driving assistance device 1 (or 1A). Here, the “computer system” includes the OS and hardware such as peripheral devices. The “computer system” also includes a WWW system equipped with a homepage provision environment (or a display environment). The “computer-readable recording medium” refers to a portable medium such as a flexible disk, an optical magnetic disk, an ROM, and a CD-ROM, as well as a memory device such as a hard disk embedded in the computer system. “Computer-readable recording medium” furthermore includes devices that hold a program for a certain period of time, such as a volatile memory (RAM) inside a computer system that serves as a server or client when a program is transmitted via a network such as the Internet or a communication line such as a telephone line.

Alternatively, some or all of these components may be realized by hardware (a circuit unit; including circuitry) using large scale integration (LSI) such as an application specific integrated circuit (ASIC), a field-programmable gate array (FPGA), a graphics processing unit (GPU), and a system on chip (SOC) or may be realized by software and hardware in cooperation.

The program described above may be transmitted from a computer system in which the program is stored in a memory device or the like to another computer system via a transmission medium, or by transmission waves in the transmission medium. Here, the “transmission medium” that transmits the program refers to a medium that has a function of transmitting information, such as a network (a communication network) such as the Internet or a communication line such as a telephone line. The program described above may be for realizing part of the functions described above. Furthermore, it may be a so-called differential file (a differential program) that can realize the functions described above in combination with a program already recorded in the computer system.

A form for implementing the present invention has been described above using embodiments, but the present invention is not limited to such embodiments, and various modifications and substitutions can be made within a range not departing from the gist of the present invention.

What is claimed is:

1. A driving assistance device comprising:
a recognition unit configured to recognize an external environment of a vehicle;
a detection unit configured to detect a behavior of the vehicle;
an analysis unit configured to analyze a driving behavior of a driver on the basis of a situation around the vehicle recognized by the recognition unit and the behavior of the vehicle detected by the detection unit;
an output unit configured to output at least one of an image and audio to the driver;
an input unit configured to receive an input operation from the driver;
a questioning unit configured to generate a question about a driving of the vehicle on the basis of the driving behavior and output the question to the output unit when a predetermined condition is met;
a memory unit configured to memorize a result of a reply of the driver to the question, input by the input unit; and
a storage unit configured to store correlation data indicating a correlation between a result of the analysis by the analysis unit and a result of the reply of the driver, input by the input unit,
wherein the questioning unit selects a question to be output by the output unit a next time by referring to the correlation data stored in the storage unit on the basis of a driving behavior of the driver analyzed by the analysis unit.

2. The driving assistance device according to claim 1, further comprising:
an estimation unit configured to estimate emotions of the driver on the basis of a result of the reply of the driver to at least content to be output by the output unit.

3. The driving assistance device according to claim 2,
wherein the estimation unit updates the correlation data stored in the storage unit on the basis of the estimated emotion information of the driver.

4. The driving assistance device according to claim 1,
wherein the output unit is a display unit and displays the content to be output, and
the input unit is a touch panel sensor and receives an input of a reply to the content to be output from the driver.

5. The driving assistance device according to claim 4,
wherein the input unit detects a result of moving coordinates of a pointer image by a touch operation in response to a question presented on the display unit, thereby receiving an input operation for the content to be output.

6. The driving assistance device according to claim 4,
wherein the input unit receives an input operation for the content to be output by touching an emotion model drawn on the display unit.

7. A driving assistance method for providing driving assistance, comprising:
recognizing, by a recognition unit, an external environment of a vehicle;
detecting, by a detection unit, a behavior of the vehicle;
analyzing, by an analysis unit, a driving behavior of a driver on the basis of a situation around the vehicle recognized by the recognition unit and the behavior of the vehicle detected by the detection unit;
outputting, by an output unit, at least one of an image and audio to the driver;
receiving, by an input unit, an input operation from the driver;
generating, by a questioning unit, a question about a driving of the vehicle on the basis of the driving behavior and outputting the question to the output unit when a predetermined condition is met;
memorizing, by a memory unit, a result of a reply of the driver to the question, input by the input unit; and
storing, by a storage unit, correlation data indicating a correlation between a result of the analysis by the analysis unit and a result of the reply of the driver, input by the input unit,
wherein the questioning unit selects a question to be output by the output unit a next time by referring to the correlation data stored in the storage unit on the basis of the driving behavior of the driver analyzed by the analysis unit.

8. A computer-readable non-transitory storage medium that memories a program causing a computer of a driving assistance device that provides driving assistance to execute:
recognizing, by a recognition unit, an external environment of a vehicle,
detecting, by a detection unit, a behavior of the vehicle,
analyzing, by an analysis unit, a driving behavior of a driver on the basis of a situation around the vehicle recognized by the recognition unit and the behavior of the vehicle detected by the detection unit,
outputting, by an output unit, at least one of an image and audio to the driver,
receiving, by an input unit, an input operation from the driver,
generating, by a questioning unit, a question about a driving of the vehicle on the basis of the driving behavior and outputting the question to the output unit when a predetermined condition is met,
memorizing, by a memory unit, a result of a reply of the driver to the question, input by the input unit,
storing, by a storage unit, correlation data indicating a correlation between a result of the analysis by the analysis unit and a result of the reply of the driver, input by the input unit, and
selecting a question to be output a next time by referring to the stored correlation data on the basis of the analyzed driving behavior of the driver.
